(19) United States
(12) Patent Application Publication
(10) Pub. No.: US 2017/0223776 A1
(43) Pub. Date: Aug. 3, 2017

(54) ELECTRIC HEATING DEVICE AND PREPARATION METHOD THEREFOR

(71) Applicants: Zhengxian Song, Zhangjiagang City, Jiangsu (CN); Yanjun XIE, Anji County, Zhejiang (CN)

(72) Inventor: Yanjun XIE, Anji County, Zhejiang (CN)

(73) Assignee: Zhengxian Song, Zhangjiagang City, Jiangsu Province (CN)

(21) Appl. No.: 15/327,918

(22) PCT Filed: Jul. 21, 2015
(86) PCT No.: PCT/CN2015/084556

§ 371 Date: Apr. 11, 2017

(30) Foreign Application Priority Data
Jul. 21, 2014 (CN) 201410348403.5
May 6, 2015 (CN) 201510228879.X

(51) Int. Cl. H05B 3/14; H05B 3/02

(52) U.S. Cl. CPC H05B 3/146; H05B 3/023

(57) ABSTRACT

The present invention provides an electric heating device and its preparation method; the said electric heating device includes at least one PTC electric heating element and radiation fin; the said PTC electric heating element includes positive and negative electrodes and PTC element between positive and negative electrodes; the said radiation fin is located at outer surface of the said PTC electric heating element; surface of the said radiation fin_with no physical connection to the said PTC electric heating element, is uncharged. State-of-the-art flat aluminum tube or aluminum tube is not used for the electric heating device provided in the present invention, which not only saves costs, but also reduces heat resistance in intermediate link of flat aluminum tube, enhances heat exchange efficiency and increases volumetric power density.

### TECHNICAL FIELD

This invention involves an electric heating device (or called as an electric heater) and its preparation/manufacturing method, especially including a PTC electric heating device without using metal flat tubes but with higher heat exchanger efficiency as well as its manufacturing method.

### BACKGROUND ART

PTC, short for Positive Temperature Coefficient, is characterized by free contact, no noise and long service life etc. Further, it has switching characteristics including sensitive to heat, current-limiting and time delay etc. Thus, as a new thermistor material, it can be used for switching and heating. For example, in the switch field, it can be applied in small household appliances such as refrigerator startup, electric transformer protection, SPC exchange protection as well as mosquito dispellers, hair curlers and electric irons etc. In the thermo field, it can be used to manufacture warmers, clothes dryers, air curtain machines and air conditioners etc due to its stable properties, rapid warming and less affected by mains voltage fluctuation.

The PTC electric heating device (or called as PTC electric heater) is glued by ripple heat dissipation aluminum strips after assembled by several single chips by adopting PTC thermosensitive polymers or ceramic parts. It is characterized by small heat resistance, high heat exchange efficiency and high security. That is to say, with fan troubles, the power of the PTC electric heating device will be automatically decreased sharply due to insufficient heat dissipation. At that moment, the surface temperature of the PTC electric heating device maintains around the Curie temperature (usually 220° C.) so as to avoid “redness” phenomena and decrease accident probability greatly.

At present, the basic structure of PTC electric heating devices on the market includes a section that consists of rectangular metal flat tubes (or called as mental sleeves). The electrical heating element and insulating layer are equipped inside mental flat tubes, of which the electric heating element, composed by positive electrode and negative electrodes and a PTC element between positive and negative electrodes is wrapped by the insulating layer, which is made from plastic films. Further, some radiator elements (or called as radiation fins) are pasted on two larger exterior heat-dispersing surfaces of metal flat tubes. The radiator element includes a length of continuous bending corrugated aluminum tapes, both sides of which are welded with two aluminum plates. The aluminum plates at the outer wall of metal flat tubes and one side of radiator parts are glued together, see details in FIG. 1. Therefore, at present, the PTC electric heating devices on the market have relatively low heat transfer efficiency.

Nowadays, many technologies have improved PTC electric heating devices. For instance, the Chinese patent CN201119017Y published a kind of PTC electric heating device, whose radiator parts' profile is made from several side-by-side triangles. This structure improves heat transfer efficiency, but its degree of improvement is limited. Further, the side-by-side form also increases material consumption. Besides, the Chinese patent CN201146614Y published a kind of PTC electric heating device. The dielectric filling is used to seal the end of PTC core tubes (metal flat tubes). Though this patent improves insulating, water-resistance and dustproof properties, its heat transfer efficiency becomes lower. The Chinese patent CN103179701A published a heating element that is used in the electric heating device of motor vehicles, which aims to improve the insulating layer based on the current technologies by setting up several upholders around containers. More importantly, the patents CN101902845A, CN102668691A, CN102434968A and CN103179700A improved PTC electric heating devices, but did not change low heat transfer efficiency and high manufacturing cost.

### CONTENTS OF THE INVENTION

This invention provides an electric heating device without metal flat tubes as well as its manufacturing method aiming to improve heat transfer efficiency, increase volumetric power density, reduce heat resistance in intermediate links and decrease manufacturing cost.

This invention provides an electric heating device comprising at least one PTC electric heating element and one radiation fin; wherein, the PTC electric heating element comprises a positive electrode, a negative electrode and a PTC element located between the positive electrode and the negative electrode; the radiation fin is located on outer surface of the PTC electric heating element;

the surface of the radiation fin with no physical connection to the PTC electric heating element, is uncharged.

The radiation fin defined in this invention refers to the element that dissipates heat generated by the PTC electric heating element to the air. Preferably, the said radiation fin comprises a plurality of fins arranged in order; or the said radiation fin comprises a plurality of fins arranged in order and at least one side plate arranged along the direction of fin arrangement, furthermore, the said fins are bonded or welded with side plate. Of course, except for the above said optimized radiating-fin structures, others with fins, side plates and intermediate bulkheads are also available.

Preferably, the above said radiation fin can be made from any metals with good heat-conducting property, such as stainless steel, Al and aluminum alloy (optimized) etc. The above said radiation fin with two side plates can be made from heat dissipation aluminum strip (or called as aluminum strip).

An insulating layer is provided between the radiation fin and the PTC electric heating element; or, an insulating layer is provided on the radiation fin surface with no physical connection to the PTC electric heating element.

Of which, the “non-touch surface” shares the same meaning as “isolated surface”.

Of which, the above said insulating layer functions as insulation and heat conduction, which is also called as a conductive insulating layer.

The above said electric heating device of this invention can be any of structures from A) to -C):

A) The above said electric heating device comprising at least one PTC electric heating element and at least two radiation fins;

the radiation fins comprise a plurality of fins arranged in order and two side plates arranged along direction of the fins arrangement, the plurality of fins are located between the two side plates by bonding or welding;

furthermore, between every two adjacent radiation fins a PTC electric heating element is located, and the radiation fins are associated with the PTC electric heating element;

the insulating layer is provided between each radiation fin and each PTC electric heating element.

B) The above said electric heating device comprising at least one PTC electric heating element and at least two radiation fins;

the radiation fin comprises a plurality of fins arranged in order, or the radiation fins comprise a plurality of fins arranged in order and a side plate arranged along direction of the fins arrangement, moreover by bonding or welding, the fins are located on the same side of the plate;

furthermore, between every two adjacent radiation fins a PTC electric heating element is located, and the radiation fins are associated with the PTC electric heating element;

the insulating layer is provided between each radiation fin and each PTC electric heating element.

C) The said electric heating device comprising at least one PTC electric heating element and at least two radiation fins; wherein,

the radiation fin comprises a plurality of fins arranged in order, or the radiation fins comprise a plurality of fins arranged in order and a side plate arranged along direction of the fins arrangement, moreover by bonding or welding, the fins are located on the same side of the plate;

furthermore, between every two adjacent radiation fins a PTC electric heating element is located, and the radiation fins are associated with the PTC electric heating element;

an insulating layer is arranged on the radiation fin surface with no physical connection to the PTC electric heating element.

The bulkhead is provided among several well-ordered fins in the above said radiation fins of this invention.

Of which, if there exists a PTC electric heating element or part of a PTC electric heating element with no physical connection to radiation fins in the above said electric heating device, then an insulating layer can be provided on the outer surface of the PTC electric heating element or part of it with no physical connection to radiation fins.

Preferably, the said electric heating device also includes a sealing element that seal parts of PTC elements that are exposed between positive and negative electrodes; more preferably, it can seal two ends and sides of PTC electric heating elements.

Preferably, the said insulating layer can be made from one or more kinds of materials selected from insulating polymeric material, insulating ceramic material (including ceramic powder and insulating ceramic paints) or and ceramic-doped insulating composite polymeric material. The preferred material for insulating layers would be ceramics. Ceramic-doped silica gel would be better, which can provide preferable heat conduction effect.

Preferably, the above said insulating layer is made from one or more kinds of materials selected from silica gel, organic silicon resin, inorganic silicon, polyimide, polyester, Teflon, epoxy resin, acrylate glue, acrylic glue, benzoxazine and ceramic-doped silica gels. The said silica gel includes organic silica gel.

Of which, preferably, the materials of the above said insulating layer are diluted by some diluent (silicone oil preferably).

In a preferred example, the above said insulating layer is made from one or more kinds of materials selected from silica gel or silica gel with ceramics. The silicone oil is used as the diluent.

In the above contents of this invention, the silicone oil with its weight ratio of 10%-50% would be preferably used as the diluent in the mixture composed by materials in the insulating layer and the said diluent.

In a preferred example, the said radiation fin is attached to outer surface of the said PTC electric heating element on the said sprayed silica gel insulating layer after surface of the said silica gel insulating layer is coated with thermally conductive silica gel.

Preferably, the method of providing the said insulating layer is one or combination of coating, flatting and wrapping, of which coating is a preferred way.

The so-called coating in this invention is a general term of coating or adhesive construction technology.

Preferably, the above said coating method means one or combination of spraying, brush coating, roller painting, deposition, dip-coating, adhesive injecting, screen printing, roller coating, electrophoresis and doctor coating, of which spraying, dip-coating and deposition are preferred ways.

The spraying method includes plasma spraying, flame spraying, detonation-gun spraying, high-pressure spraying and normal temperature spraying etc.

This invention provides an electric heating device without metal flat tubes. The above said metal flat tube can also be called as aluminum flat tube or aluminum tube.

Besides, this invention provides a method for manufacturing electric heating device, including the following steps:

step 1: stacking up and fixing a positive electrode, a PTC element and a negative electrode orderly to form a PTC electric heating element;

step 2: bringing a radiation fin into contact with outer surface of at least one PTC electric heating element; and the radiation fin surface, with no physical connection to the PTC electric heating element, is uncharged.

Of which, step 2 includes:

providing the PTC electric heating element and the radiation fin, and alternately arranging the PTC electric heating element and the radiation fin, and the radiation fin is attached to an outer surface of the PTC electric heating element to form an electric heating device;

wherein an insulating layer is provided between the radiation fin and the PTC electric heating element, or an insulating layer is provided on the radiation fin surface with no physical connection to the PTC electric heating element.

In a preferred example, the insulating layer and the radiation fin are provided by one or more methods selected from the group:

arranging the insulating layer on the outer surface of the PTC electric heating element, and then, bonding the radiation fin to the outer surface of the PTC electric heating element; or

arranging the insulating layer on the radiation fin surface with physical connection to the PTC electric heating element and then bonding the radiation fin to the outer surface of the PTC electric heating element; or

the insulating layer is provided on the radiation fin surface where with no physical connection to the PTC electric heating element, and then, the PTC electric heating element is provide to overlie on the area of the radiation fin surface where the insulating layer is not provided; or

the radiation fin is brought into contact with the PTC electric heating element, and then, the insulating layer is provided on the exposed surface.

Steps about how to install sealing elements are also included in one preferred example of this invention. The said sealing element seals at least part of PTC elements exposed between the positive electrode and negative electrode; the silicone sealing element is preferably used to seal two ends and/or two sides of the said PTC electric heating element.

In the above said manufacturing method, the preferred measure also includes step 3: install fasteners or fastening bolts outside the electric heating device in step 2.

In the above said manufacturing method, the preferred measure also includes step 3: install frames outside the electric heating device in step 2.

Preferably, the frame comprises at least one fixing hole at two sides;

Preferably, the said electric heating device comprises at least one conductive interface. The positive electrode or negative electrode is connected to wires through the said interface.

Preferably, an electric connection point is set up on the above said interconnecting piece; the positive electrode connects wires through this electric connection point.

Preferably, an electric connection point is set up on the above said interconnecting piece; the negative electrode connects wires through this electric connection point.

Preferably, the above said insulating layer can be made from one or more kinds of materials selected from insulating polymeric material, insulating ceramic material (including ceramic powder and insulating ceramic paint) or ceramic-doped insulating composite polymeric material. The preferred material for insulating layers would be ceramics. Ceramic-doped silica gel would be better, which can provide preferable heat conduction effect.

The said ceramics are like aluminum nitride powders and/or alumina powders.

Preferably, the above said insulating layer is made from one or more kinds of materials selected from silica gel (including organic one), organic silicon resin, inorganic silicon, polyimide, polyester, Teflon, epoxy resin, acrylate glue, acrylic glue, benzoxazine and ceramic-doped silica gel.

Of which, preferably, the materials of the above said insulating layer are diluted by some diluent (silicone oil preferably).

In a preferred example, the above said insulating layer is made from one or more kinds of materials selected from silica gel or silica gel with ceramics. The silicone oil is used as the diluent.

In the above contents of this invention, the silicone oil with its weight ratio of 10%-50% would be preferably used as the diluent in the mixture composed by materials in the insulating layer and the said diluent.

In a preferred example, the surface of silica gel insulating layer is coated with heat conductive silicones. Then, the above said radiation fins are bonded on the outer surface of the said electrode of the pained silica gel insulating layer.

Preferably, the method of providing the said insulating layer is one or combination of coating, flatting and wrapping, of which coating is a preferred way.

The so-called coating in this invention is a general term of coating or adhesive construction technology.

Preferably, the insulating layer is provided by means of one or more methods selected from: spraying, brushing, roller coating, deposition, dip coating, adhesive injecting, screen printing, roll coating, electrophoresis, and doctor coating, of which spraying, dip-coating and deposition are preferred ways.

The spraying method includes plasma spraying, flame spraying, detonation-gun spraying, high-pressure spraying and normal temperature spraying etc.

In the above said contents of this invention, the positive and negative electrodes can be connected with the PTC element via binding agents. The silica gel is a preferred bonding agent.

In the above said contents of this invention, if not specified, the contact surface of electrodes (positive and negative electrodes) with PTC element is the internal surface (inside), the contact surface of electrodes with the radiation fin is the external surface (outside); the contact surface of side plates with fins is the internal surface, the other surface of side plates is the external surface; if the side plate is also an electrode, then its internal surface also means the electrode's external surface; the electric heating said in this invention shares the same meaning with electrical heating, both of which transfer electric energy into heat energy.

This invention also provides another electric heating device, which comprises at least one PTC electric heating element and one radiation fin;

the PTC electric heating element consists of several PTC elements; the radiation fin is located at outer surface of the PTC electric heating element;

the radiation fin with no physical connection to the PTC electric heating element is uncharged.

Wherein, preferably, the radiation fin includes an electric side plate. The fin is connected on the side plate. The base plate gets contact with the PTC element.

Wherein, the fin surface with no physical connection to the side plate is uncharged. More preferably, an insulating layer is provided on the fin surface with no physical connection to the side plate, or an insulating layer is provided between the fin and the side plate.

It shall be understood that in the above said contents, technicians in this field can conduct combination between various aspects and various preferred examples without any limitations. Besides, the above said combination is also included in this invention.

The electric heating device provided by this invention does not use metal flat tubes that are usually used in the routine technology, which not only saves cost, but reduces heat resistance of intermediate links, improves heat exchange efficiency and adds volumetric power density.

The electric heating device said in this invention has been applied into some electric heating systems or places as well as air conditioners, electric radiators and dryers etc.

In the above said contents of this invention, the so-called uncharged surface means the radiation fin surface exposed in the air is uncharged. Thus, there will be no danger caused by electric leakage or people will not suffer from electric shock hazard. Preferably, the so-called radiation fin surface of this invention is uncharged. It would be any of the following conditions: one, an insulating layer is coated on the surface of radiation fins; the surface of the insulating layer is uncharged; two, the radiation fin is separated from the PTC electric heating element via an insulating layer; for example isolated from electrodes, though the mental on the radiation fin surface is exposed in the air, its surface is uncharged.

In the above said contents of this invention, the radiation fin, preferably located at the outer surface of electrodes, is connected with the PTC electric heating element. Preferably, the radiation fin can be connected with the PTC electric heating element according to below said any of conditions: one, the radiation fin contacts with the PTC electric heating element directly; if contacted with electrodes directly, there is no insulting layer in the middle; two, an insulating layer is provided on the outer surface of the PTC electric heating element, the radiation fin is bonded on the outer surface of the PTC electric heating element with an insulating layer, that is, the radiation fin is boned on the insulating layer.

Based on the above mentioned, this invention includes the following positive effects:

On the basis of the current PTC electric heating device, some unnecessary parts such as metal flat tubes can be removed, which can not only reduce cost greatly, but decrease heat transfer resistance and improve heating efficiency.

This invention not only achieves insulation and improves heat transfer performance of the insulating layer greatly, but helps with automatic large-scale production so as to enhance production efficiency and quality stability of mass production, reduce about 2/3 original manual works and decrease production cost sharply by introducing new product structures, insulating heat conductive materials (such as silica gel with heat conductive particles) and new construction technologies (such as coating or spraying).

### BRIEF DESCRIPTION OF THE DRAWINGS

FIG. 1 refers to a structure diagram of the radiation fin in example 1 of this invention;

FIG. 2 refers to a structure diagram of the radiation fin and insulating layer positions in example 1 of this invention;

FIG. 3 refers to a structure diagram of the PTC electric heating element in example 1 of this invention;

FIG. 4 refers to a structure diagram of the PTC electric heating element and insulating layer positions in example 1 of this invention;

FIG. 5 refers to a structure diagram of inside the aluminum tube section of the electric heating device based on the current technology;

FIG. 6 refers to a structure diagram of the electric heating device in example 1 of this invention;

FIG. 7 refers to a structure diagram of an electric heating with frames of this invention;

FIG. 8 refers to a structure diagram of the radiation fin in example 2 of this invention;

FIG. 9 refers to a structure diagram of the position relationship among the radiation fin, the insulating layer and the electrodes;

FIG. 10 refers to a structure diagram of the electric heating device in example 2 of this invention;

FIG. 11 refers to a structure diagram of the radiation fm and insulating layer position in example 3 of this invention;

FIG. 12 refers to a structure diagram of the electric heating device in example 3 of this invention;

FIG. 13 refers to a structure diagram of the electric heating device in example 4 of this invention;

FIG. 14 refers to a structure diagram of a radiation fin in example 8 of this invention;

FIG. 15 refers to a structure diagram of the electric heating device in example 8 of this invention;

FIG. 16 refers to a structure diagram of the electric heating device in example 9 of this invention;

wherein, fin-1; side plate-2; insulating layer-3; PTC element-4; electrode slice-5; PTC electric heating element-6; insulating film-7; aluminum flat tube (or aluminum tube)-8; radiation fin-9; electric heating device in this invention-10; frame-20; base plate-21; top plate-22; radiation fin 1-91; radiation fin 2-92; radiation fin 3-93.

### REDUNDANT DESCRIPTION OF THE INVENTION

The implementation method of this invention will be described according to the attached drawing. The parts with the same structure will be marked with the same drawing with omitted descriptions.

It shall be pointed out that in order to make clearer, the following definitions are made: the side plate in contact with the PTC electric heating element is defined as the base plate, while that with no physical contact with the PTC electric heating element is defined as the top plate. Thus, a radiation fin may include one base plate and one top plate or a radiation fin may have two base plates; of course, if the base plate is an electrode, then the radiation fin does not need a base plate.

The radiation fins in examples of this invention at least have the following ones: one, the radiation fin comprises a set of fins and two side plates (including one top plate and one base plate) two, the radiation fin comprises a set of fins and one side plate (top plate); three, the radiation fm comprises a set of fins; of course, there are other forms of radiation fins except for the above mentioned.

The base plate said in examples of this invention can be a sub component of the radiation fin or an electrode used for conductivity or a sub component of the radiation fin and an electrode used for conductivity;

### EXAMPLE 1

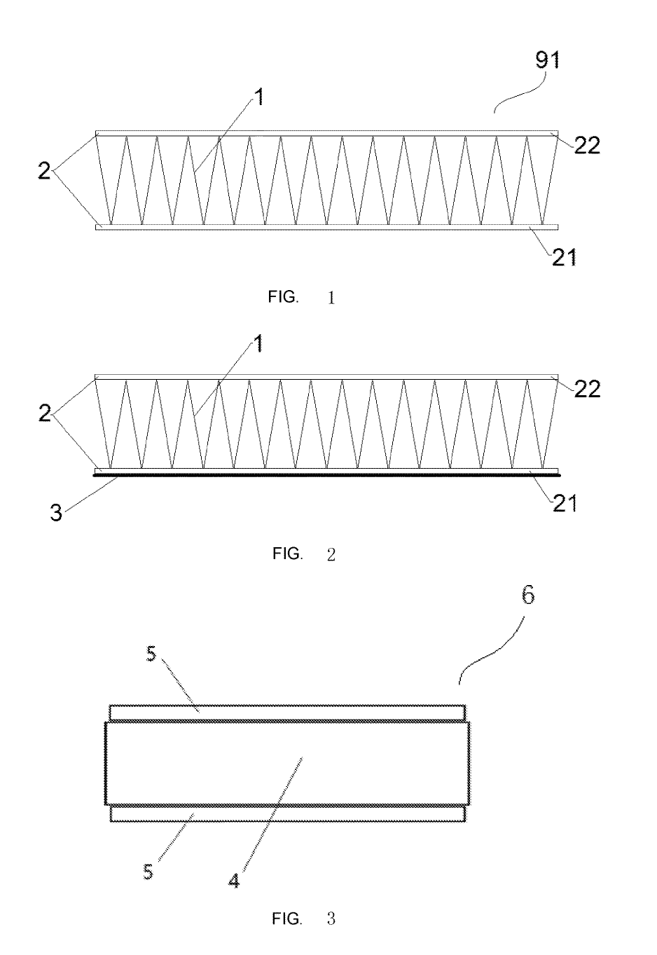

As showed in FIG. 1, this invention provides a sketch map of an aluminum radiation fin 9 (or called as a radiating fin, a heat dissipation element, a heat dissipation aluminum strip or an aluminum strip). The radiation fin 9 is composed by a set of fins 1 and side plates 2 at two sides of fins, which also comprises the radiation fin 91. As shown in FIG. 2, the insulting layer 3 is provided on the surface (namely, outside of the base plate 21) of the radiation fin 91 in contact with the PTC electric heating element 6. That is, the insulating layer 3 is provided between the radiation fin 91 and the PTC electric heating element 6 aiming to form an uncharged surface on the radiation fin 91 with no physical connection to the PTC electric heating element.

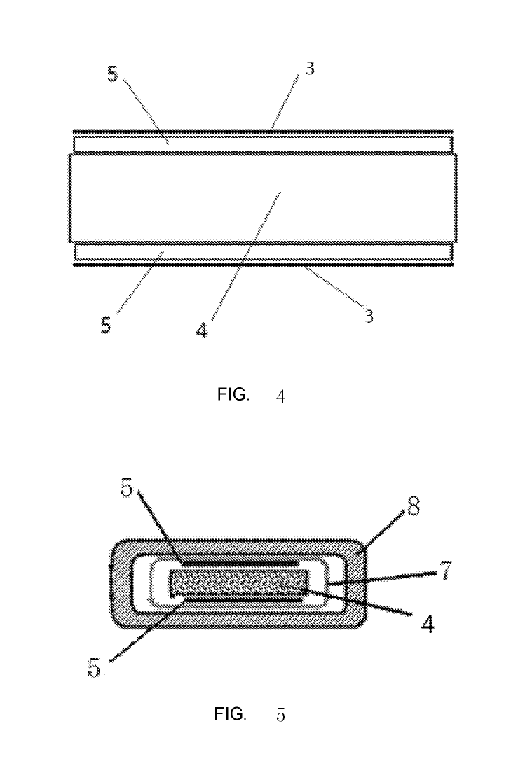

As shown in FIG. 3, this invention provides a sketch map of a PTC electric heating element 6 (or called a PTC electrode assembly). The positive and negative electrodes 5 made from stainless steel are provided at the top and bottom of the PTC element 4. As shown in FIG. 4, the insulating layer 3 is provided on the outer surface of the PTC electric heating element 6.

The insulating silica gel or insulating silica gel with ceramics powder is sprayed on the outer surfaces of the PTC electric heating element 6 (or electrodes) under high pressure condition as the insulating layer 3. Further, the insulating silica gel can also be sprayed on right and left sides of the PTC electric heating element under high pressure condition, which can also be sprayed on the exposed parts at the front and back sides of the PTC electric heating element (except for the plate lug of electrodes). Of course, as an alternative of the above mentioned, the insulating silica gel or insulating silica gel with ceramics powder can also be sprayed on the surface of aluminum radiation fin 91 in contact with the PTC electric heating element 6 as the insulting layer 3. The position of those two kinds of insulating layers 3 can be alternative or both.

Then, the PTC electric heating element 6 and the radiation fin 91 are arranged alternatively after being coated with heat conductive silicone for further bonding. As showed in FIG. 6. A PTC electric heating device is formed by stacking up the PTC electric heating element 6 and the radiation fin 91, of which, the insulating layer 3 is provided between the PTC electric heating element 6 and the radiation fin 91.

The heat conductive silicone can choose to use the same or different material as the insulating layer 3. The spraying of the insulating silica gel and the coating of the heat conductive silicone can be achieved in one-time or two-time processing steps. The insulating silica gel can be diluted before spraying so as to reduce its viscosity; for example, the 10%-50% silicone oil can be used to conduct attenuation. Further, the heat conductive particles (such as Al₂O₃ ceramic powder) can be mixed into the heat conductive silica gel and insulating silica gel to improve heat conductivity coefficient. The doping ratio shall be evaluated comprehensively according to heat conduction effect and bonding effect etc, which can vary from 10% to 50%.

In FIG. 7, the outside is the frame 20 with a conductive connector. The wires connect the positive and negative electrodes with the external power supply via the above said conductive connector. The inside is a PTC electric heating device 10 stacked up by the PTC electric heating element 6 and the radiation fin 9.

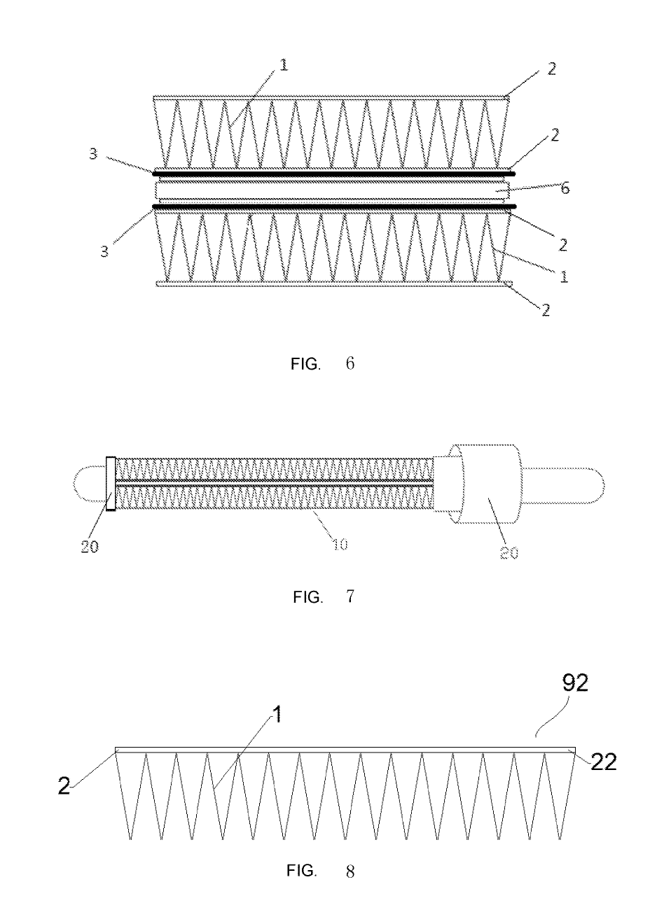

The FIG. 5 refers to a structure diagram of the section of the PTC electric heating element with an aluminum flat tube 8 under the current technology. As showed in the FIG., the PTC electric heating element with an aluminum flat tube 8 under the current technology includes the central PTC element 4, positive and negative electrodes 5 at two sides, external insulating film 7 as well as the outermost Al flat tube 8. Then, the PTC electric heating element with an aluminum flat tube is connected to the common radiation fin 9 so as to achieve heat dissipation effects. It can be seen that the PTC electric heating device under the current technology is characterized by complicated structures and many parts.

In the practical batch production, the insulating layer can be provided by the spraying technology, which is beneficial to the automatically mass-produced process design so as to replace the present manual operation. This can improve production efficiency greatly and reduce about 2/3 labor. More importantly, the batch production has stable and reliable quality as well as sharply decreased production cost.

In the examples, the silica gel is used as the insulating layer to replace the traditional polyimide film. The silica gel with its insulating function can also be used as bonding materials, which can help to reduce heat contact resistance among surfaces and improve heat transfer performance. Moreover, the silica gel can be mixed with heat conductive particles (such as ceramic powder) to further enhance its heat conductivity; for example, the heat conductivity coefficient of the silica gel can reach over 2.0 W/m.K after adding AIN or Al₂O₃ powder, while that of the traditional polyimide film is only about 0.2 W/m.K. Those obvious technical effects can hardly be achieved by the insulation structure of the traditional polyimide film.

### EXAMPLE 2

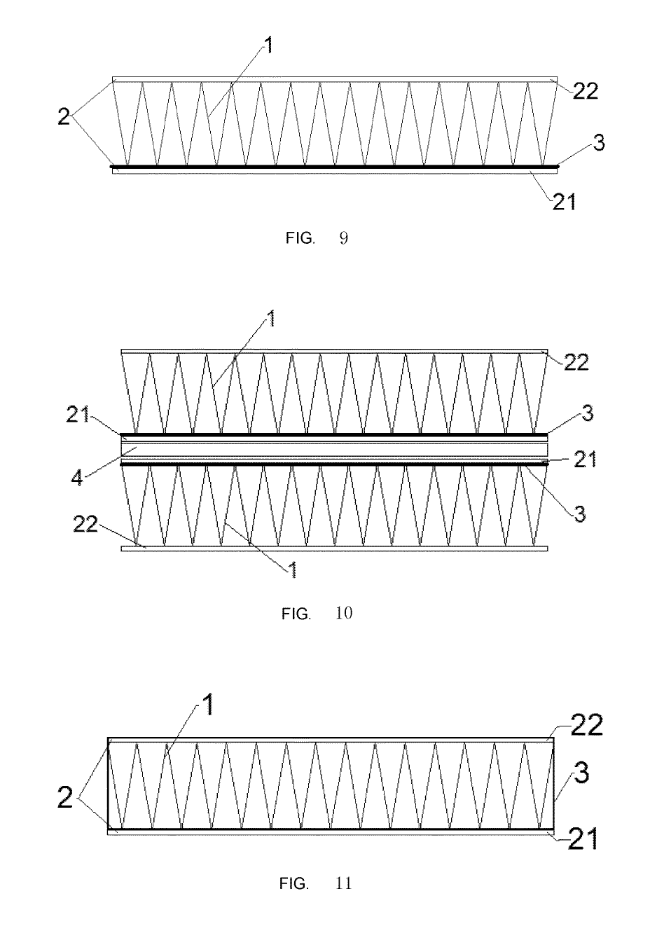

The FIG. 8 refers to a structure diagram of the radiation fin in example 2 of this invention. As showed in the FIG., the radiation fin 9 in this example is another radiation fin 92, which is composed by fins 1 and the side plate 2 of one side (namely top plate 22). That is, this radiation fm does not include the base plate 21. As showed in FIG. 9, the side plate 2 (namely top plate 21) of another side is taken as the electrode slice 5, outside which is equipped with the insulating layer 3. Then, the radiation fin 92 in the FIG. 8 is boned on the outside of the electrode slice 5.

The electric heating device in the examples can be achieved by the following ways: bond the parts showed in FIG. 9 on two sides of several PTC elements 4 to form the electric heating device of this invention. The insulating layer 4 is provided between this radiation fin 92 and the electric heating element 6.

The electric heating device in the examples can be achieved by the following way: bond two radiation fins 92 showed in FIG. 8 on two sides of the PTC electric heating element 6 with the insulating layer 3 showed in FIG. 4 to form the electric heating device of this invention. The insulating layer 3 is provided between this radiation fin 92 and the PTC electric heating element 6.

In this example, the insulating layer 3 is provided on the surface of positive and negative electrodes 5 (or base plate 21) in contact with fins 1; that is, the surface of the radiation fin 92 with no physical connection to the PTC electric heating element 6 is uncharged.

Of which, the fin 1 is bonded with the base plate 21 in this example, but they can also be connected via pressing, screws and clamping tools etc, which is not limited to the above mentioned; the fin 1 is bonded with the top plate 22, but they can also be connected via welding, pressing, screws and clamping tools etc, which is not limited to the above mentioned. The method of providing the said insulating layer 3 is one or combination of coating, flatting and wrapping. The method of coating the said insulating layer 3 is one or combination of spraying, brushing, roller painting, dip coating, adhesive injecting, screen printing, roll coating, electrophoresis and doctor coating. Further, the spraying method can be divided into ceramic power melt spraying and liquid spraying under high temperature, which is not limited to those. The insulating layer 3 is made from polymer insulating materials or ceramics insulating materials or polymer composite insulating materials with ceramics; or, the insulating layer 3 is made from rubber, or resin or plastic; or the said insulating layer 4 was made from organic silicon, or inorganic silicon, or polyimide, or polyester, or epoxy resin, or polyimide adhesive or acrylic adhesive.

Thus, in this example, the insulating layer 3 is provided on the internal surface of the base plate 21, which avoid additional insulating treatment of the fin 1 and the top plate 22.

The FIG. 10 refers to a structure diagram of the electric heating device in example 2 of this invention. It can be seen in the FIG. that the electric heating device comprises the radiation fin 92 and the PTC electric heating element 6. Further, the insulating layer 3 is provided between the radiation fin 92 and the PTC electric heating element 6. Compared with the current technology showed in FIG. 5, the electric heating device of this example saves the specialized positive and negative electrodes 5, the insulating film 7 and the Al flat tube 8 to have a simpler structure. The base plate 5 functions as the positive and negative electrodes 5, which not only achieves insulation, simplifies structure, but improves heat efficiency.

### EXAMPLE 3

The FIG. 11 refers to a structure diagram of the radiation fin and the external insulating layer in example 3 of this invention. An insulating layer 3 is provided on the surfaces of the radiation fin 91 showed in FIG. 1 with no physical connection to the PTC element 4. As showed in the FIG., the radiation fin includes the fin 1 and the side pate 2 at two sides; further, the insulating treatment is conducted on the whole fin 1 (including the side), the internal side and two sides of the base plate as well as the external side and two sides of the top plate 22 except for the outer side of the base plate so as to obtain the insulating layer 3 as showed in the FIG. That is, the insulating layer 3 is provided on the parts of the radiation fm 91 with no physical connection to the PTC element. Thus, the surface of the radiation fin 91 with no physical connection to the PTC element 4 is uncharged. The base plate 21 in this example is taken as an electrode slice.

In the example, the insulating layer can be provided as follows: two radiation fins 91 are provided at two sides of the PTC element 4 to form a PTC electric heating device; wrap the plate lug and conduct other protection so as to achieve dip coating;

In this example, the electric heating device can also be made as follows: first of all, make the PTC electric heating element 6, then install a set of fins 1 and a top plate 22 at two sides of the PTC electric heating element 6 to form an uninsulating electric heating device; then, the insulating layer 3 is added on it through dip coating to form an electric heating device of this invention with insulating functions.

The insulating layer 3 can be made from polymer insulating materials or ceramic insulating materials or polymer composite insulating materials with ceramics, of which the polymer insulating materials are made from one or combination of organic silicone, resin and plastic.

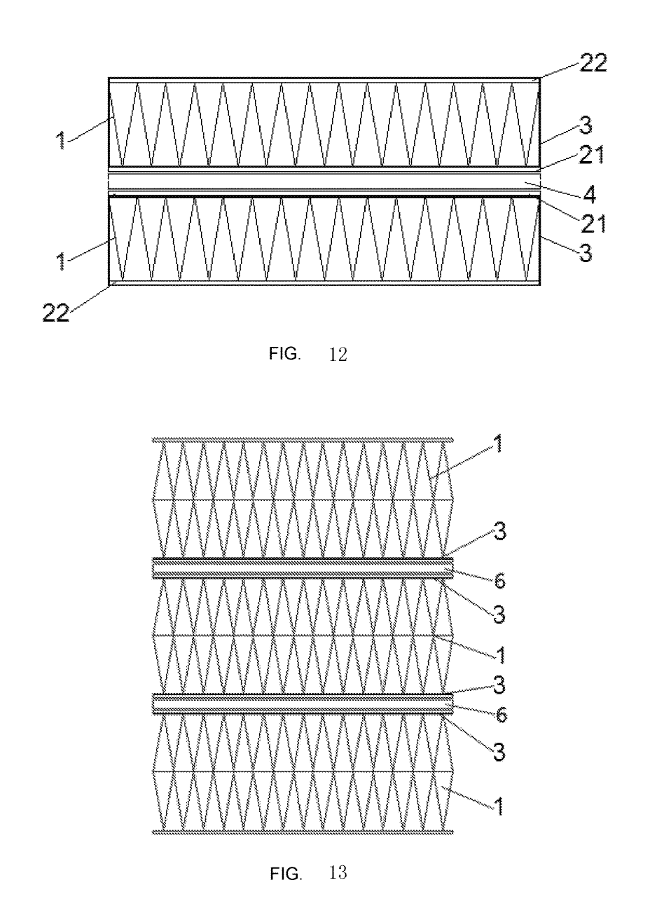

The FIG. 12 refers to a structure diagram of the electric heating device in example 3 of this invention. As showed in the FIG., the PTC element 4 and two radiation fins 91 are stacked up together. Similar to the above said example 2, this example simplifies the structure of the current technology by removing the specialized positive and negative electrodes 5 at two sides, the external insulating film 7 and the outmost Al flat tube 8. As showed in the FIG., the surface (that is, the external surface of the base plate 21) between the PTC element 4 and the radiation 91 is not treated by insulation; other parts except for the plate lug are treated by insulation. Thus, the outer side of the base plate 21 functions as the electrode slice.

In this way, it not only achieves insulation, simplifies structures, but improves heat efficiency. The side plate 2 (that is, the base plate 21) of the radiation fin 9 is taken as the electrode slice 5 of the PTC electric heating element 6, which saves the specialized positive and negative electrodes.

In this example, the radiation fm can be divided by two ways: one, the fin 1, base plate 21 and top plate 22 are taken as the radiation fin 91 of this example; two, the fin 1 and the top plate 22 are taken as the radiation fin 92 in this example.

The insulating layer 3 is provided on the part of the radiation fin 91 with no physical connection to the PTC element 4. That surface is insulated or uncharged. Or, the radiation fin 9 also refers to the radiation fin 92 as showed in FIG. 8. The surface of the radiation fin 92 with no physical connection to the PTC electric heating element 6 is insulated or uncharged.

### EXAMPLE 4

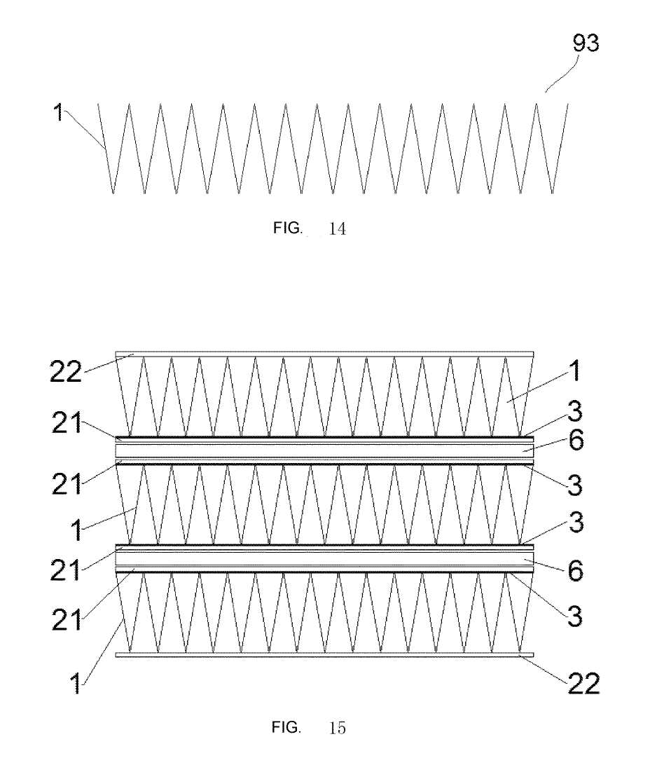

As showed in FIG. 13, the basic stricture and principle of the electric heating device in this example is almost the same as that in the above said example 2. The difference lies in the fact that this electric heating device has three radiation fins and two PTC electric heating elements; the radiation fin has double-layer fins 1. The bilateral radiation fin is composed by one double-layer fin 1, the intermediate bulkhead and the top plate; the radiation fin in the middle is composed by the double-layer fin 1 and the intermediate bulkhead. The insulating layer 3 is provided between the radiation fm and the PTC electric heating element 6.

In this way, the double-layer fin 1 can achieve better heat dissipation effects, which also saves the specialized electrode slices.

### EXAMPLE 5

Similar to FIG. 6, this example is mostly similar to those of example 1. The difference lies in the fact that the insulating layer 3 is made from Al₂O₃ ceramic powder; further, the Al₂O₃ ceramics are sprayed on the outer surface of the base plate or the radiation fin 91 of the PTC electric heating element.

The performances of the above said ceramics coating are as follows:

Insulation resistance>20 MΩ; electric strength 1800 VDC@1 min; electric leakage<2 mA;

Temperature tolerance: −45 to 260° C.

Heat conductivity: 20˜30 W/m·K

Heat expansion coefficient: 8.8×10⁻⁶/° C.

### EXAMPLE 6

The PTC electric heating element 6 is formed by the positive and negative electrodes 5 and the PTC element 4 by referring to example 1. The polyimide film is pasted and bonded on the outer surface of the PTC electric heating element 6.

The bonding agent is coated on the surface of the radiation fin 91 with physical connection to the PTC electric heating element 6. Two radiation fins 91 are bonded on the bilateral surfaces of the PTC electric heating element 6.

EXAMPLE 7

The PTC electric heating element 6 is made from fastening the positive and negative electrodes 5 and the PTC element 4 by referring to example 1. Then, the polyimide film is used to wrap the above said PTC electric heating element 6 (lapping). Only the plate lug of the electrode slice is exposed to connect with the external wires.

The bonding agent is coated on the surface of the radiation fin 91 with physical connection to the PTC electric heating element 6. The radiation fin 91 is bonded at the outer surface of the PTC electric heating element 6.

### EXAMPLE 8

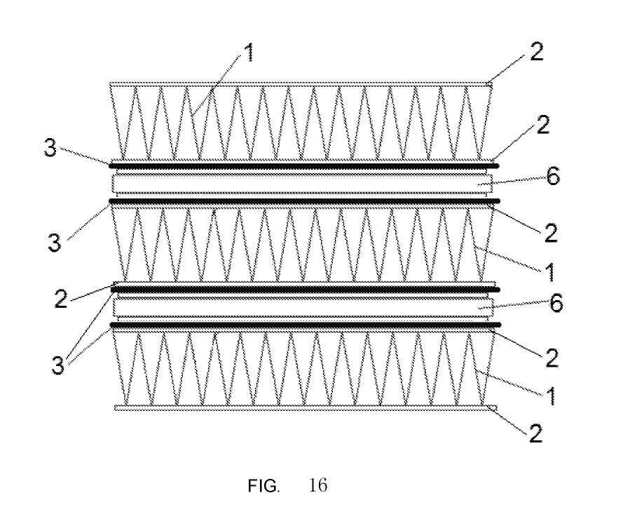

As showed in FIG. 14, the radiation fin is composed by a set of fins. The FIG. 15 refers to a structure diagram of the electric heating device in example 8 of this invention. The difference from the example 2 lies in the fact that the example 8 is composed by two PTC electric heating elements 6 and three radiation fins, of which two radiation fins at the up and down sides is the radiation fin 92 as showed in FIG. 8. The radiation fin in the middle is the radiation fin 93 as showed in FIG. 14 (that is, the fin 1).

### EXAMPLE 9

The FIG. 16 refers to a structure diagram of the electric heating device in example 9 of this invention. The difference from the example 1 lies in the fact that the example 9 is composed by several (such as two) PTC electric heating elements 6 and several (such as three, it is one more than that of the PTC electric heating element), of which all the radiation fins are the radiation fin 91 as showed in FIG. 1. Relatively speaking, the multi-layer electric heating element with integrated structures is more suitable for PTC electric heating device of automobile air conditionings.

It shall be pointed out that the PTC element provided by this invention includes ceramic PTC and polymer PTC that can be applied in various heating fields. Particularly, it is suitable for the air conditioning heating field. Further, the bonding is the main connection mode. The insulating layer is mainly provided by coating, which is not limited to that.

The above said examples are only several preferable ones of this invention, which are only illustrative but restrictive. The professional technicians can conduct many changes, revisions and equivalent replacement within the spirit and range limited by the requirements of this invention, but all of which will be fallen into the protection scope. Therefore, the changes and revisions within the spirit and range of this invention shall be included into the scope of this invention.

1-22. (canceled)

23. An electric heating device comprising at least one PTC electric heating element and one radiation fin; wherein,
the PTC electric heating element comprises a positive electrode, a negative electrode and a PTC element located between the positive electrode and the negative electrode; the radiation fin is located on outer surface of the PTC electric heating element;
an insulating layer is provided between the radiation fin and the PTC electric heating element, or an insulating layer is provided on the radiation fin surface with no physical connection to the PTC electric heating element; and therefore, the radiation fin surface, with no physical connection to the PTC electric heating element, is uncharged;
the insulating layer is provided by means of coating.

24. The electric heating device according to claim 23, wherein the insulating layer is made from one or more kinds of materials selected from insulating polymeric material, insulating ceramic material, and ceramic-doped insulating composite polymeric material.

25. The electric heating device according to claim 24, wherein the material of the insulating layer is made from one or more kinds of materials selected from silica gel, organic silicone resin, inorganic silicon, polyimide, Teflon, polyester imide, epoxy resin, acrylate adhesive, acrylic adhesives, benzoxazines, ceramic-doped silica gels.

26. The electric heating device according to claim 23, wherein the insulating layer is provided by means of one or more methods selected from: spraying, brushing, roller coating, deposition, dip coating, adhesive injecting, screen printing, roll coating, electrophoresis, and doctor coating.

27. The electric heating device according to claim 23, comprising at least one PTC electric heating element and at least two radiation fins, wherein,
the radiation fins comprise a plurality of fins arranged in order and two side plates arranged along direction of the fins arrangement, the plurality of fins are located between the two side plates by bonding or welding;
furthermore, between every two adjacent radiation fins a PTC electric heating element is located, and the radiation fins are associated with the PTC electric heating element;
the insulating layer is provided between each radiation fin and each PTC electric heating element.

28. The electric heating device according to claim 23, comprising at least one PTC electric heating element and at least two radiation fins; wherein,
the radiation fin comprises a plurality of fins arranged in order, or the radiation fins comprise a plurality of fins arranged in order and a side plate arranged along direction of the fins arrangement, moreover by bonding or welding, the fins are located on the same side of the plate;
furthermore, between every two adjacent radiation fins a PTC electric heating element is located, and the radiation fins are associated with the PTC electric heating element;
the insulating layer is provided between each radiation fin and each PTC electric heating element.

29. The electric heating device according to claim 23, comprising at least one PTC electric heating element and at least two radiation fins; wherein,
the radiation fin comprises a plurality of fins arranged in order, or the radiation fins comprise a plurality of fins arranged in order and a side plate arranged along direction of the fins arrangement, moreover by bonding or welding, the fins are located on the same side of the plate;
furthermore, between every two adjacent radiation fins a PTC electric heating element is located, and the radiation fins are associated with the PTC electric heating element;
the insulating layer is provided on the radiation fin surface with no physical connection to the PTC electric heating element.

30. A method for manufacturing the electric heating device according to claim 23, comprising the steps of:
step 1: stacking up and fixing a positive electrode, a PTC element and a negative electrode orderly to form a PTC electric heating element;
step 2: bringing a radiation fin into contact with outer surface of at least one PTC electric heating element; and the radiation fin surface, with no physical connection to the PTC electric heating element, is uncharged; wherein,
the step 2 comprises:
providing the PTC electric heating element and the radiation fin, and alternately arranging the PTC electric heating element and the radiation fin, and the radiation fin is attached to an outer surface of the PTC electric heating element to form an electric heating device;
wherein an insulating layer is provided between the radiation fin and the PTC electric heating element, or an insulating layer is provided on the radiation fin surface with no physical connection to the PTC electric heating element; the insulating layer is provided by means of coating.

31. The method according to claim 30, wherein the insulating layer and the radiation fin are provided by one or more methods selected from the group:
arranging the insulating layer on the outer surface of the PTC electric heating element, and then, bonding the radiation fin to the outer surface of the PTC electric heating element; or
arranging the insulating layer on the radiation fin surface with physical connection to the PTC electric heating element and then bonding the radiation fin to the outer surface of the PTC electric heating element; or
the insulating layer is provided on the radiation fin surface where with no physical connection to the PTC electric heating element, and then, the PTC electric heating element is provide to overlie on the area of the radiation fin surface where the insulating layer is not provided; or
the radiation fin is brought into contact with the PTC electric heating element, and then, the insulating layer is provided on the exposed surface.

32. The method according to claim 30, wherein the insulating layer is provided by means of one or more methods selected from: spraying, brushing, roller coating, deposition, dip coating, adhesive injecting, screen printing, roll coating, electrophoresis, and doctor coating.

33. The method according to claim 30, wherein the insulating layer is made from one or more kinds of materials selected from: insulating polymeric material, insulating ceramic material, and ceramic-doped insulating composite polymeric material.

34. The method according to claim 33, wherein the material of the insulating layer is selected from the ceramic-doped silica gel.
